(19) United States
(12) Patent Application Publication
(10) Pub. No.: US 2004/0224845 A1
(43) Pub. Date: Nov. 11, 2004

(54) Plant treatment composition

(76) Inventors: Alastair J. Forsyth, Krugersdorp (ZA); Johannes A. Hough, Mpumalanga (ZA); Justin T. Roberts, Roodepoort (ZA)

Correspondence Address: NIXON & VANDERHYE, PC, 1100 N GLEBE ROAD, 8TH FLOOR, ARLINGTON, VA, 22201-4714, US

(21) Appl. No.: 10/481,030

(22) PCT Filed: Jun. 14, 2002
(86) PCT No.: PCT/ZA02/00100

(30) Foreign Application Priority Data
Jun. 20, 2001 (ZA) 2001/5038

(51) Int. Cl. A01N 57/00

(52) U.S. Cl. 504/194

(57) ABSTRACT

This invention relates to a plant treatment composition formed by the mixture of a phosphorus compound, and an organic polar solvent. The invention also relates to the use of such a composition as a fertilizer and/or a fungicide.

### TECHNICAL FIELD

This invention relates to a plant treatment composition in the form of a phosphorus containing solution. In one embodiment of the invention the plant treatment composition may comprise a fertilizer. In one particularly important embodiment of the invention the plant treatment composition may comprise a composition for treating plant diseases, especially fungi

### BACKGROUND ART

The use of phosphorous acid and phosphites as fertilizers and/or fungicides are well known. When used as a fungicide the phosphorous acid is often injected into the trunk of the plant, but it may also be sprayed onto the leaves of the plant, painted onto the stem and/or applied to the soil around the plant stem.

One well-known current commercial phosphorous acid trunk injection solution for use on avocado trees comprises an un-neutralised aqueous phosphorous acid solution. However, in order to obtain successful application by injection a large number of holes have to be drilled in each trunk (up to about 20 holes) and the solution has to be injected in small quantities at frequent intervals. This is necessary due to the phytotoxicity of the phosphorous acid solution which causes leaf burn if not applied in this manner. A further problem is that the holes ‘bleed’ profusely and secondary infection of the holes becomes a problem. Severe necrosis of hard wood around the injection sites was also observed.

It is also know to use neutralised aqueous phosphorous acid solutions as trunk injection solutions. Usually KOH and K₂CO₃ are used to neutralise such phosphorous acid solutions. The neutralised solutions have reduced phytotoxicity (less leaf burn) and reduced hole damage.

It has now been found that if a solution comprising a mixture of phosphorous acid (and/or phosphites) and ethanol is used as a trunk injection solution in avocado trees, Improved/uptake and translocation are obtained.

Phosphorus containing compounds and, in some cases, organic solvents are disclosed in U.S. Pat. No. 4,075,324; Patent Abstracts of Japan Vol. 2000, no. 01, and JP-A-11 292711; WPI Section Ch. Week 198724, AN 1987-16 7038 XP002217001 and JP-A-62 099309; GB-A-1 320 870; EP-A-0 079 579; WPI Section Ch, Week 199748, AN 1997-513752 XP002217002and CN-A-1125 2141; and CABA: accession no. 89:118114, XP002217000, vol. 11, 1988, pages 32-34.

### DISCLOSURE OF THE INVENTION

According to the present invention there is provided a plant treatment composition formed by the mixture of

a phosphorus compound; and

an organic polar solvent.

The plant treatment composition preferably comprises a solution, preferably with the phosphorus compound being dissolved in the organic polar solvent.

The solution may comprise a concentrated solution of the phosphorus compound. Preferably the solution has a concentration from 1 mol.dm⁻³ to 7.5 mol.dm⁻³ of the phosphorus compound. More preferably the concentration is from 3 mol.dm⁻³ to 7.5 mol.dm⁻³. Most preferably the concentration is about 6.1 mol.dm⁻³.

The phosphorus compound may comprise an acid, preferably a compound selected from the group consisting of phosphorous acid, hypophosphorous acid, polyphosphorous acid, polyhypophosphorous acid, and salts thereof.

Preferably the phosphorus compound comprises phosphorous acid.

The organic polar solvent preferably comprises a solvent for the phosphorus compound. The organic polar solvent may comprise an alcohol. The alcohol may include more than one hydroxyl group, but preferably it includes a single hydroxyl group. Preferably it comprises ethanol.

In one embodiment of the invention the plant treatment composition may consist of only the phosphorus compound dissolved in the organic polar solvent and without the presence of a basic compound. This is especially the case where the pH of the composition does not play an important role in the application method. If foliar application, for example, is considered, the pH of the solution may need to be adjusted in order that the composition has a suitable pH for foliar uptake. In such a case a basic compound or compounds may have to be added to the mixture.

Alternatively or additionally, the composition may also include one or more plant nutrients such as macro-nutrients and/or micro-nutrients.

The composition mixture may accordingly include a basic compound which increases the pH of the composition. The basic compound may comprise a compound including an alkali metal salt or an alkaline earth metal salt. In one embodiment of the invention it may comprise a potassium salt. The potassium salt may comprise K₂CO₃ or KOH. It will be appreciated that the potassium from the potassium salt can also serve as a macro-nutrient.

The pH of the composition may be adjusted as required depending on factors such as the plants to be treated or the method of application of the plant treatment composition. If foliar application is contemplated, the pH of the composition should be suitable for foliar uptake. Usually this is at a pH from about 5 to 7. Preferably the pH is from about 6 to 7. Most preferably it is about 6.5. In the case of trunk injection or drench applications the pH should usually be between about 0.5 and about 9. Preferably the pH is from about 4 to 8. Most preferably it is about 6.5.

A plant nutrient such as a source of nitrogen may also be added. The nutrient may comprise urea, ammonium nitrate, potassium nitrate, magnesium nitrate or calcium nitrate.

The composition may also include water. Water may be added in cases where a compound such as a basic compound and/or nutrient is added which is not soluble in the polar organic solvent, but which is soluble in water, or where such compound is added in such an amount that it does not fully dissolve in the organic solvent and where water is required to substantially fully solubilise the compound.

The volume percentage of water can vary greatly but ideally it may be at about 39.5%.

The plant treatment composition may also include a surfactant, especially in the case where an organic polar solvent and water are included in the composition. The surfactant may be added to ensure that a monophasic solution forms.

The surfactant may comprise any suitable surfactant, and in one embodiment of the invention it may comprise propylene glycol.

It will be appreciated that the composition of the plant treatment composition is expressed in terms of the starting materials used in the composition. It will be appreciated that in certain cases the phosphorus compound, the polar organic solvent and other compounds of the mixture such as a basic compound or nutrients may react with each other to form reaction products and/or they may dissolve to form dissolved species. For example where the composition includes a mixture of phosphorous acid (H₃PO₃); ethanol, potassium carbonate (K₂CO₃) and water, dissolved species of, KH₂PO₃, K₂HPO₃, as well as salts of the potassium and the ethanol may form.

A source of boron may also be added.

The composition may be buffered. Preferably an imidazole and hydrochloric acid buffer is added.

The plant treatment composition may comprise a fertiliser.

In a preferred embodiment of the invention the plant treatment composition may be used for treating plants against plant diseases. Preferably the plant treatment composition comprises a fungicide. Preferably it comprises a fungicide suitable for use against Oomycetes, preferably for use against Peronosporales, preferably for use against Phytophthora, and Pythium and Plasmopara species.

According to another aspect of the present invention there is provided a method of preparing a plant treatment composition comprising the step of mixing together:

a phosphorus compound; and

an organic polar solvent.

Other compounds, in the amounts and ratios as indicated above may also be added to the mixture.

According to another aspect of the present invention there is provided a plant treatment composition prepared by the method substantially as described hereinabove.

The invention also relates to the use of the plant treatment composition substantially as described hereinabove for treating plants or a locus, especially a locus where plants are cultivated or are to be cultivated. Preferably the plant treatment composition is used as a fungicide. Alternatively or additionally the composition may be used as a fertiliser. The composition may be applied to the plants, for example by spraying the plants (preferably spraying the foliage of the plants), painting the stems or drenching their roots. Preferably the solution is injected into plants, and preferably into the stems of plants.

The invention also relates to a method of treating a plant or a locus comprising applying to the plant or locus the plant treatment composition substantially as described hereinabove.

The invention will now be further described by means of the following non-limiting examples:

### EXAMPLE 1

Composition with Surfactant in the Form of Propylene Glycol

Ethanol (95% ethanol, 5% methanol) in an amount of 200 ml was introduced into a beaker. The ethanol was stirred and 505 g of dry phosphorous acid (99% purity) was added to the ethanol. The solution was stirred until almost all the phosphorous acid dissolved.

Anhydrous potassium carbonate (99,5% purity) in an amount of 440 g was slowly added to the solution in order to maintain the temperature below 65° C. The potassium carbonate did not fully dissolve. The mixture was thoroughly stirred and 395ml water was then slowly added thereto. This mixture was thoroughly stirred until there was no further effervescence. Two layers formed.

Propylene glycol (surfactant) in an amount of 130 ml was then added to the mixture under constant stirring. A green dye in the form of 0.005 g Hexacol Acid Green dissolved in 5 ml of water was then added to provide a monophasic solution with a green colour.

The resultant solution had a pH of about 6.5 and a specific gravity of about 1,322 g/ml.

### EXAMPLE 2

Composition without Surfactant (Propylene Glycol)

Ethanol (95% ethanol, 5% methanol) in an amount of 200 ml was introduced into a beaker. The ethanol was stirred and 505 g of dry phosphorous acid (99% purity) was added to the ethanol. The solution was stirred until almost all the phosphorous acid dissolved.

Water in the amount of 462 ml was then added to the solution, which was stirred until all phosphorous acid had dissolved.

Anhydrous potassium carbonate (99.5% purity) in an amount of 320 g was slowly added to the solution in order to maintain the temperature below approx. 65° C. Once all the potassium carbonate had been added, the solution was stirred until no more effervescing occurred. A monophasic solution was obtained.

Lastly a dye, in the form of Hexacol Acid Green, in the amount of 0.005 g dissolved in 5 ml water was added to the solution.

The resultant solution had a pH of about 3.0 and a specific gravity of about 1.31 g/ml.

### EXAMPLE 3

Comparison with Aqueous Phosphorous Acid Solution

1. Preparation of Aqueous Phosphorous Acid Solution.

Phosphorous acid flakes (99% purity) in the amount of 205 g, was dissolved in 300 ml water.

Anhydrous potassium carbonate (99.5% purity) in an amount of 169 g was slowly added to the solution to limit the amount of effervescing. The solution was stirred until no further effervescing was observed.

Potassium hydroxide flakes (90% purity) in an amount of 122 g was slowly added to the solution. The solution boiled due to the exothermic reaction. This was also stirred until all had dissolved.

Urea low biuret (46% nitrogen mass/mass) in the amount of 10 g was then added and dissolved.

A buffering system in the form of imidazole/hydrochloric acid buffer (3.5 g imidazole/2.43 g hydrochloric acid 32%) was then introduced into the solution.

A dye in the form of 0.005 g Hexacol Acid Blue, dissolved in 5 ml water was then added to the solution.

The volume of the solution was then topped-up with water to 1 000 ml.

The resultant solution had a pH of about 7.2 and a specific gravity of about 1.24 g/ml.

2. Application

The aqueous solution and a solution according to example 1 was each applied to four different avocado trees of the Pinkerton cultivar. The trees were about 8 years old with a height of about 4.0 m and a diameter of about 4.0 m. The trunk diameters were about 200 mm and the trees had a slight woodiness which indicated that they were mildly affected by root rot.

Four injection holes were provided in each tree at a height of about 100 to 150 mm above ground level. Each hole was about 30 mm deep and had a diameter of 4.8 mm. The holes were angled downwards at 20 to 30° to the horizontal.

The aqueous solution was applied in an amount of 80 ml per tree thus providing a dose of 1.0 g phosphorous acid per square meter of tree area (calculated as height×width).

The ethanol solution of example 1 was applied in an amount of 20 ml per tree providing a dose of 0.625 g phosphorous acid per square meter of tree area (calculated as height×width).

The trees were injected on 8 Mar. 2000 and fruit were sampled at 14, 28 and 42 days after injection to determine phosphorous acid residue therein.

3. Results

The phosphorous acid residues (mg/kg) in duplicated analyses of the flesh of the avocado fruit were as follows:

| | Aqueous solution [Mean | |
|---|---|---|
| | value | Ethanol solution (example 1) |
| Days after | of phosphorous acid residue | [Mean value of phosphorous |
| injection | (mg/kg)] | acid residue (mg/kg)] |
| 14 | Not detectable | 8.2 |
| 28 | Not detectable | 25.6 |
| 42 | 26.8 | 12.8 |

4. Discussion

With the ethanol solution according to the invention the phosphorous acid moved into the fruit much quicker than in the case with the aqueous solution, that is despite the fact that the aqueous solution was applied at a higher dosage rate of phosphorous acid. Accordingly the ethanol solution according to the invention is absorbed at a quicker rate and is more mobile in the plant compared to the aqueous solution.

Another important aspect is that with the ethanol solution according to the invention maximum residue of phosphorous acid in the fruit was obtained at about 28 days, and two weeks later it reduced to about half of the maximum residue. A maximum allowable phosphorous acid residue value of 50 ppm in the fruit is generally considered to be acceptable. It is known that when an aqueous solution of phosphorous acid (without ethanol) is injected into avocado trees the residue value of the phosphorous acid only dips below 50 ppm after 100 days (the withholding period). Due to the high mobility of the solutions according to the present invention it is expected that the withholding period will drop to about 30 days.

The significance of the above is that if it is required to treat a tree against root rot such treatment could previously not take place within 100 days of picking when the known aqueous compositions were used. With a composition according to the present invention the withholding period can be drastically reduced. It has also been found that in South Africa late summer rains frequently create conditions favourable for the development of Phytophthora root rot and there is a practical need for trunk injections in the February/March period which falls within the 100 days withholding period of early maturing fruit. The present invention makes this treatment possible.

It has also been observed that with the solution according to example 1 injection holes in the tree trunk healed substantially completely when they were inspected about 8 months after injection. This is opposed to the situation where conventional unneutralised aqueous solutions of phosphorous acid were used, in which case healing of injection holes is a major problem.

Lower volumes of the composition according to the invention can also be used and smaller syringes can accordingly be used. Due to the lower volumes, the injections are a lot quicker. The composition also causes less damage to trees.

It will be appreciated that many variations in detail are possible without thereby departing from the scope and spirit of the invention.

1. Use of an alcohol in combination with a phosphorus compound selected from the group consisting of phosphorous acid, hypophosphorous acid, polyphosphorous acid, polyhypophosphorous acid, and a salt of any one thereof to enhance absorption by, and/or mobility in a plant of the phosphorus compound to which plant the alcohol and phosphorus compound is in use applied.

2. The use of an alcohol in combination with a phosphorus compound selected from the group consisting of phosphorous acid, hypophosphorous acid, polyphosphorous acid, polyhypophosphorous acid, and a salt of any one thereof in the preparation of a plant treatment composition wherein the alcohol enhances absorption by, and/or mobility in a plant of the phosphorus compound to which plant the plant treatment composition is in use applied.

3. The use of either one of claims 1 or 2 wherein the phosphorus compound is dissolved in the alcohol to form a plant treatment solution.

4. The use of claim 3 wherein the phosphorus compound comprises phosphorous acid and/or a salt thereof; and the solvent comprises ethanol wherein the phosphorous acid and/or salt thereof is dissolved.

5. The use of claim 3 wherein the solution includes a basic compound which increases the pH of the solution.

6. The use of claim 3 wherein the solution includes a plant nutrient.

7. The use of claim 3 wherein the solution includes water.

8. The use of claim 7 wherein the solution includes a surfactant.

9. The use of claim 8 wherein Fe surfactant comprises propylene glycol.

10. The use of claim 3 wherein the plant treatment solution is a fertiliser.

11. The use of claim 3 wherein plant treatment solution is a solution for treating plants against plant diseases.

12. A plant treatment composition formed by the mixture of phosphorous acid and/or a salt thereof; and ethanol.

13. A method of preparing a plant treatment composition comprising the step of mixing together:
phosphorus compound in the form of phosphorous acid and/or a salt thereof; and
an organic polar solvent in the form of ethanol.

14. The use of a composition of claim 12 for treating plants or a locus.

15. The use of claim 14 wherein the composition is used as fertiliser.

16. The use of claim 14 wherein the composition is used as a fungicide.

17. The use of any one of claims 14 to 16 wherein the composition is injected into plants.

18. A method of treating a plant or a locus comprising applying to the plant or locus the plant treatment composition of claim 12.
